(19) United States
(12) Patent Application Publication
(10) Pub. No.: US 2016/0116572 A1
(43) Pub. Date: Apr. 28, 2016

(54) SENSOR INFORMATION OUTPUT APPARATUS, SENSOR IMAGE DISPLAY APPARATUS, DETECTION APPARATUS, AND SENSOR INFORMATION OUTPUT METHOD

(71) Applicant: FURUNO ELECTRIC CO., LTD., Hyogo (JP)

(72) Inventor: Dai TAKEMOTO, Nishinomiya (JP)

(21) Appl. No.: 14/896,233

(22) PCT Filed: Jun. 5, 2013
(86) PCT No.: PCT/JP2013/003525

§ 371 Date: Dec. 4, 2015

(51) Int. Cl. G01S 7/285; G01S 13/86; G01S 7/00; G01S 13/93; G01S 7/04

(52) U.S. Cl. CPC G01S 7/285; G01S 13/9307; G01S 7/04; G01S 7/003; G01S 13/862

(57) ABSTRACT

A sensor information output device (10) includes a receiver (12), a characteristic point extracting module (15), and a representative data outputting module (17). In the receiver (12), a radar antenna (11) receives reflection waves as reception signals, each of the reflection waves caused by a radio wave. The characteristic point extracting module (15) extracts a characteristic point from one or more of the reception signals. The representative data outputting module (17) outputs representative data of sweep data to the outside of the sensor information output device (10), the representative data corresponding to at least distance information and amplitude information of the characteristic point extracted by the characteristic point extracting module (15), the distance information indicating a distance from the radar antenna (11).

### TECHNICAL FIELD

This disclosure generally relates to a sensor information output device, which receives, as a reception signal, a reflection wave caused by one of a radio wave and a sonic wave and outputs data obtained based on the reception signal to an external display device.

### BACKGROUND ART

Generally, radar apparatuses include a sensor unit configured with, for example, a radar antenna, and an indicating unit configured with, for example, a radar image creating module. Conventionally, sweep data acquired by the sensor unit is outputted to the indicating unit while remaining an analog signal. The indicating unit converts the analog signal outputted from the sensor unit into a digital signal, performs various kinds of signal processing, and then creates a radar image.

Incidentally, an analog signal deteriorates as a transmission distance becomes longer. Therefore, radar apparatuses having a configuration in which the sweep data is converted from an analog signal into a digital signal by the sensor unit and the digital signal is outputted to the indicating unit, are recently known.

However, when the sweep data as the digital signal is outputted to the indicating unit as it is, since the data amount is large, a network traffic increases. Recently, network constructions with LAN inside ships are promoted, and it is desired to reduce the traffic of data which is outputted from instruments within the ships. Especially, wireless LANs are also promoted and in this case, since the data transfer amount per unit second(s) becomes smaller compared to wire communications, the reduction in the traffic of data which is outputted from the instruments within the ships is desired even more.

In this regard, Patent Document 1 discloses an art for reducing network traffics inside ships. Patent Document 1 discloses a radar control device for performing settings of removing an unrequired signal, etc., while checking a radar image from a remote location. The radar control device converts values of amplitudes of a predetermined section of the radar image into an average amplitude value in the predetermined section, so as to reduce the data amount.

In Patent Document 2, a stationary target object face correlator and a moving target object face correlator are provided. Each of the correlators receives sweep data. The stationary target object face correlator emphasizes stationary target objects and the moving target object face correlator emphasizes moving target objects. Further, by varying display colors for outputs of the respective correlators to be different from each other, the moving target object and the stationary target object can be differentiated from each other.

### REFERENCE DOCUMENT(S) OF CONVENTIONAL ART

### Patent Documents

Patent Document 1: JP1993-134034A

Patent Document 2: JP2913563B

### DISCLOSURE OF THE INVENTION

### Problems to be Solved by the Invention

However, when the amplitude values in the predetermined section are uniformly averaged as Patent Document 1, the quality of the data deteriorates. Therefore, the data amount of the sweep data cannot suitably be reduced.

Further, in Patent Document 2, since one of the stationary target object and the moving target object is simply emphasized and it is different from extracting only part of the data, the data amount is not effectively reduced. On the contrary, in Patent Document 2, since two kinds of signal processing are performed on a single sweep data and signals resulted therefrom are outputted, a data amount which is outputted from the sensor unit to the display device increases.

Moreover, in a case of creating a radar image by a sensor unit and transmitting data therefrom, if the radar image is displayed, for example, on a plurality of display devices, due to a variation in resolutions of the display devices, a rough radar image which is the radar image simply enlarged is displayed or, due to a mismatch in aspect ratios, a radar image with which the display is not performed at an end section of a display range or that does not fit into the display range is displayed.

Note that, the above issues not only arise in radar apparatuses, but commonly arise in overall devices which include a sensor unit and an indicating unit.

This disclosure is made in view of the above situations and mainly aims to provide a sensor information output device, which can output data suitable for drawing, while reducing an amount of data that is outputted to an indicating unit (to a display device side).

### Summary and Effects of the Invention

Problems to be solved by this disclosure are described above, and means for solving the problems and effects thereof will be described below.

According to a first aspect of this disclosure, a sensor information output device having the following configuration is provided. Specifically, the sensor information output device includes a receiver, a characteristic point extracting module, and a representative data outputting module. The receiver receives reflection waves as reception signals, each of the reflection waves caused by one of a radio wave and a sonic wave transmitted from a sensor. The characteristic point extracting module extracts a characteristic point from one or more of the reception signals. The representative data outputting module outputs representative data of the one or more of the reception signals to the outside of the sensor information output device, the representative data corresponding to at least distance information and amplitude information of the characteristic point extracted by the characteristic point extracting module, the distance information indicating a distance from the sensor.

Thus, an output data amount can significantly be reduced. Therefore, a network traffic can be reduced. Further, since data before an image creation is outputted instead of data after the image creation, an image can be drawn on a display device side corresponding to a resolution of the display device.

With the sensor information output device described above, the characteristic point extracting module preferably extracts the characteristic point based on an amplitude of the one or more of the reception signals.

Thus, in the reception signal, a position at which a target object exists can be the characteristic point.

With the sensor information output device described above, the characteristic point extracting module preferably extracts the characteristic point of the one or more of the reception signals based on a change of the amplitude of the one or more of the reception signals in one of a distance direction and an azimuth direction from the sensor.

Thus, by using the change of the amplitude in the distance direction, a point accurately indicating a distance to the target object can be the characteristic point. Moreover, by using the change of the amplitude in the azimuth direction, a point accurately indicating an azimuth at which the target object exists can be the characteristic point. Note that, the position of the target object can be detected while simultaneously changing the distance and azimuth directions.

With the sensor information output device described above, the characteristic point extracting module preferably extracts, as the characteristic point, a peak point of the change of the amplitude of the one or more of the reception signals in the one of the distance and azimuth directions from the sensor.

Thus, the peak point of the change of the amplitude generally indicates an echo at the center among echoes indicating the target object. Therefore, by outputting this point as the peak point, the point accurately indicating the position, etc., of the target object can be the characteristic point.

With the sensor information output device described above, the characteristic point extracting module preferably extracts, as the characteristic point, an inflection point of the amplitude of the one or more of the reception signals in the one of the distance and azimuth directions from the sensor.

Thus, a characteristic portion of the change of the amplitudes can be the characteristic point. Therefore, the point accurately indicating the position, etc., of the target object can be the characteristic point.

With the sensor information output device described above, the characteristic point extracting module preferably extracts, as the characteristic point, a center position of a target object that is obtained based on the change of the amplitude of the one or more of the reception signals in the one of the distance and azimuth directions from the sensor.

Thus, by having the center position of the target object as the characteristic point, the position of the target object can accurately be expressed when displaying a sensor image on the display device side.

With the sensor information output device described above, the characteristic point extracting module preferably extracts, as the characteristic point, a point obtained based on a change amount of the amplitude of the one or more of the reception signals in the one of the distance and azimuth directions from the sensor. Moreover, specifically, it is more preferable to have one of a rising point and a falling point of the amplitude as the characteristic point, or to have, as the characteristic point, a point at which the change amount of the amplitude is above a predetermined reference amount.

Thus, for example, by having the rising (or the falling) of the amplitude as the characteristic point, the point at which the detection of the target object is started (or ended) can be detected. Therefore, by utilizing the information of the detection, more accurate drawing can be performed on the display device side. Further, by taking into consideration of a point at which the change amount of the amplitude is high, for example, the rising (or the falling) of the amplitude can accurately be detected.

With the sensor information output device described above, the representative data outputting module preferably excludes, from the output target, a point of the one or more of the reception signals at which the amplitude is below a predetermined reference amount.

Thus, the portion where the target object is not detected is not outputted. Therefore, the output data amount can further be reduced.

With the sensor information output device described above, the representative data outputting module preferably assigns the amplitude of the characteristic point into one of a plurality of amplitude classes, and outputs the assigned amplitude class as the amplitude information of the characteristic point.

Thus, compared to the configuration of outputting the amplitude as it is, the output data amount can further be reduced.

With the sensor information output device described above, when the characteristic point assignment is continuously performed to the same amplitude class, the representative data outputting module preferably outputs the amplitude class and the number of the amplitude class assigned continuously, as the amplitude information of the characteristic point.

By performing run length encoding as above, the output data amount can further be reduced.

With the sensor information output device described above, the representative data outputting module preferably outputs phase information of the characteristic point.

Thus, by performing predetermined processing on the display device side on which the phase information is received, a speed of the target object can be calculated. Therefore, the image formed by taking the speed of the target object into consideration can be displayed on the display device side.

With the sensor information output device described above, the representative data outputting module preferably outputs target object determination information indicating whether the characteristic point corresponds to a target object.

Thus, whether the outputted representative data indicates the target object or noise, etc., can be notified to the display device side. Therefore, the image formed by taking one of the target object and the noise into consideration can be displayed on the display device side.

With the sensor information output device described above, the representative data outputting module preferably outputs movement information indicating whether a target object corresponding to the characteristic point is in move.

Thus, a moving target object and a stationary target object can be displayed differentiated from each other, in the case of creating the image on the display device side.

With the sensor information output device described above, the representative data outputting module preferably outputs a speed of the target object.

Thus, the moving target object can be displayed in a mode corresponding to the speed in the case of creating the image on the display device side.

With the sensor information output device described above, the representative data outputting module preferably outputs azimuth information of the characteristic point in addition to the distance and amplitude information of the characteristic point.

Thus, in a case where target objects at various azimuths are detectable by the sensor, the azimuth of each target object can be notified to the display device side.

With the sensor information output device described above, the representative data outputting module preferably wirelessly outputs the representative data.

In general, wireless communication uses less data transfer amount per unit second(s) compared to wire communication. Therefore, by suppressing a communication amount for output as the present application, the representative data can naturally be outputted wirelessly.

With the sensor information output device described above, the representative data outputting module preferably outputs, to the outside of the sensor information output device, the one or more of the reception signals before the characteristic point is extracted therefrom, in addition to the representative data.

Thus, the sensor image can be created on the reception side by using both of the representative data and the normal data.

According to a second aspect of this disclosure, a sensor image display device is provided. Specifically, the sensor image display device includes a representative data receiving module, an image creating module, and a display unit. The representative data receiving module externally receives, as representative data of one or more reception signals, information obtained by extracting a characteristic point based on an amplitude of the one or more reception signals and including at least distance information and amplitude information of the characteristic point. The image creating module creates a sensor image indicating a target object in the vicinity, based on the representative data inputted from the representative data receiving module. The display unit displays the sensor image created by the image creating module.

Thus, a reception data amount can significantly be reduced. Therefore, a network traffic can be reduced. Further, since data before an image creation is outputted instead of data after the image creation, for example, even when enlarged display is performed, a sensor image can be redrawn to prevent the image from becoming rough.

According to a third aspect of this disclosure, a detection device including the sensor information output device and the sensor image display device described above is provided.

According to a fourth aspect of this disclosure, a method of outputting sensor information of which description is as above is provided.

### BRIEF DESCRIPTION OF DRAWING(S)

FIG. 1 is a block diagram illustrating a configuration of a radar apparatus according to one embodiment of this disclosure.

FIG. 2 shows a view illustrating a situation where a single sweep data (reception signals continuous in a distance direction) is acquired, and a chart illustrating the acquired single sweep data.

FIG. 3 shows a chart illustrating the sweep data after signal processing is performed and a chart after characteristic points are extracted therefrom.

FIG. 4 is a view conceptually illustrating representative data which is outputted from a sensor information output device to a sensor image display device.

FIG. 5 shows a view illustrating a plurality of adjacent sweep data (reception signals continuous in an azimuth direction) are acquired, and a chart in which amplitudes at a predetermined distance are aligned.

FIG. 6 shows a chart after signal processing is performed and a chart after a characteristic point is extracted therefrom, regarding a chart in which amplitudes at a predetermined distance are aligned.

FIG. 7 is a view conceptually illustrating representative data which is outputted from the sensor information output device to the sensor image display device.

FIG. 8 shows views illustrating another example of a method of comparing amplitudes.

FIG. 9 is a block diagram illustrating a configuration of a radar apparatus according a modification.

### MODE(S) FOR CARRYING OUT THE INVENTION

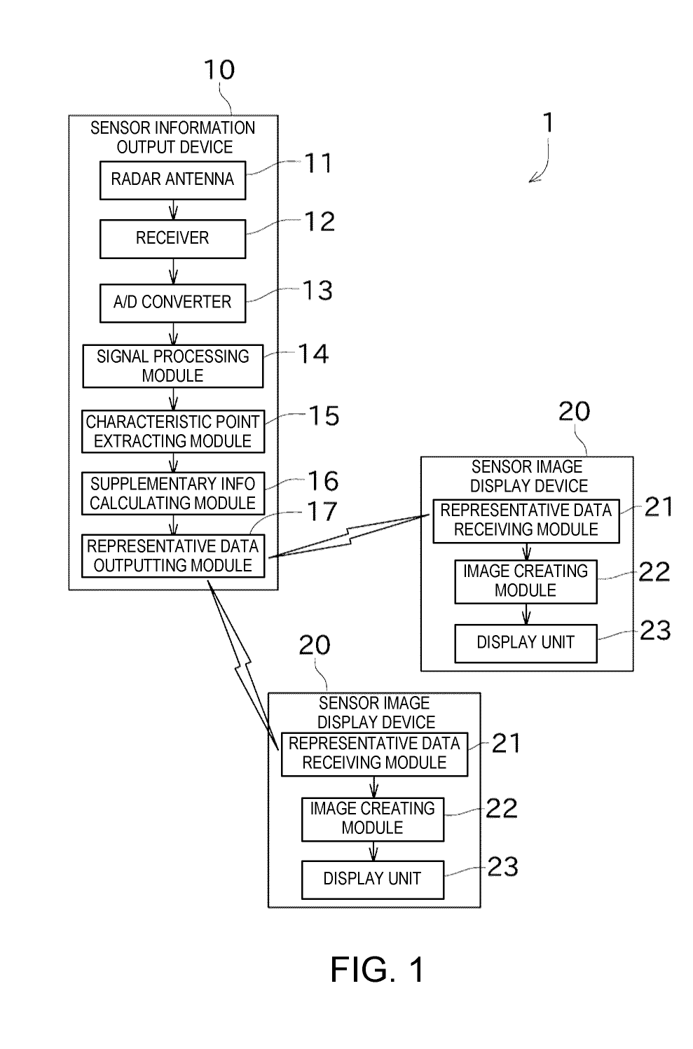

Next, one embodiment of this disclosure is described with reference to the drawings. FIG. 1 is a block diagram illustrating a configuration of a radar apparatus according to the embodiment of this disclosure.

A radar apparatus (detection device) 1 of this embodiment is configured as a radar apparatus for a ship. The radar apparatus 1 is configured to be transmittable of pulse-shaped radio waves and receive reflection waves from target objects in the vicinity of the ship (e.g., land and another ship on the sea). Further, the radar apparatus 1 can create a radar image indicating positions and shapes of the target objects based on the received reflection waves and display it.

Hereinafter, the configuration of the radar apparatus 1 is described. As illustrated in FIG. 1, the radar apparatus 1 includes a sensor information output device (sensor unit) 10 and a sensor image display device 20. Note that, although FIG. 1 illustrates a configuration in which two sensor image display devices are provided, a configuration in which a single sensor image display device is provided may be adopted, or even three or more sensor image display devices may be provided.

The sensor information output device 10 detects the target object, performs various kinds of processing on signals indicating the detection result, and then outputs the processed signals to the sensor image display device 20. The sensor information output device 10 includes a radar antenna (sensor unit) 11, a receiver 12, an A/D converter 13, a signal processing module 14, a characteristic point extracting module 15, a supplementary information calculating module 16, and a representative data outputting module 17.

The radar antenna 11 is configured to transmit pulse-shaped radio waves having a strong directivity and receive, as a reception signal, a reflection wave from each of the target objects. With this configuration, a distance r from the ship to the target object can be obtained by measuring a time length from the radar antenna 11 transmits the pulse-shaped radio wave until it receives the reflection wave. Further, the radar antenna 11 is configured to be 360° rotatable on the horizontal plane and repeat the transmission and reception of the radio wave while changing the transmission direction of the pulse-shaped radio wave (while changing the angle of the radar antenna 11). By this configuration, the target objects on the plane in the vicinity of the ship can be detected over 360°.

Note that, alternative to the pulse radar, a CW (continuous wave) radar or a Pulse-Doppler radar may be used. Further, alternative to the above configuration, a radar apparatus with a configuration in which the radar antenna is not rotated may be used. For example, a radar apparatus with a configuration having antenna elements over the entire circumference and a radar apparatus configured to detect only in a specific direction, such as forward, do not need rotate the radar antenna.

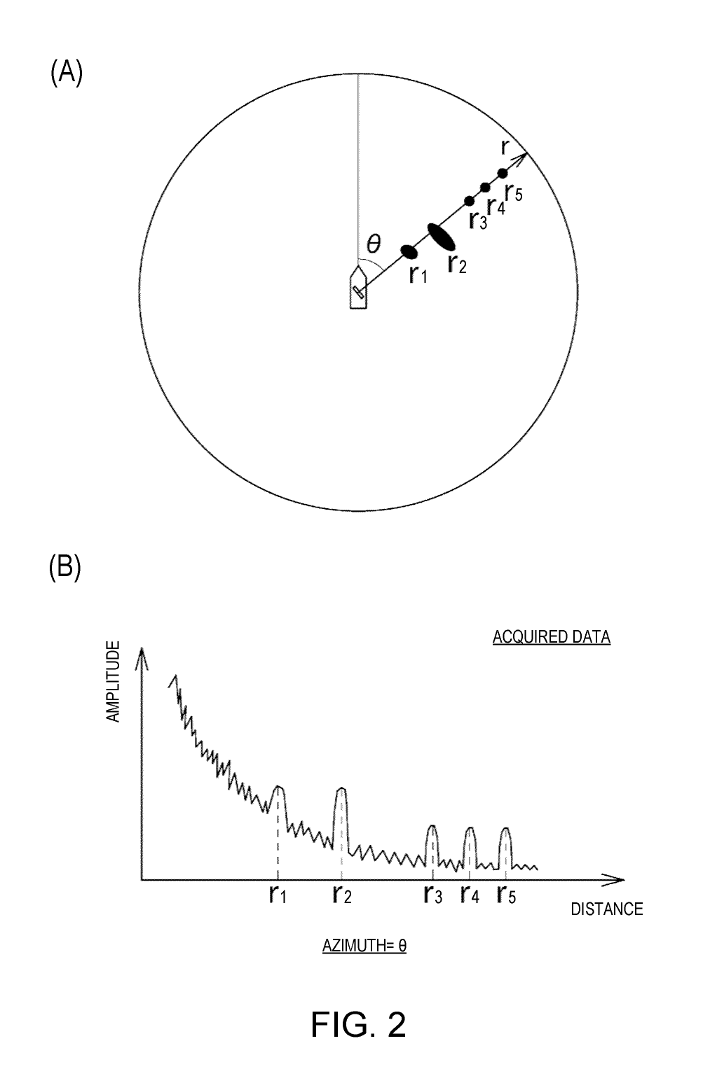

Note that, in the following description, an operation of transmitting and receiving the pulse-shaped radio wave by the radar antenna 11 is referred to as a sweep, and data obtained from the sweep is referred to as “sweep data.” Therefore, the sweep data can be expressed as data including one or more reception signals. FIG. 2(A) illustrates a situation where the pulse-shaped radio wave is transmitted to a direction that is at an angle θ from a heading. FIG. 2(B) illustrates sweep data (reception signals continuous in the distance direction) obtained in the corresponding sweep. The sweep data is data including a distance from the radar apparatus (radar antenna) and an amplitude. According to FIG. 2(B), it can be understood that the amplitudes are high at positions where the target objects exist in FIG. 2(A).

The receiver 12 receives the sweep data outputted by the radar antenna 11, and outputs it to the A/D converter 13.

The A/D converter 13 receives the sweep data outputted by the receiver 12, and converts it from an analog signal into a digital signal.

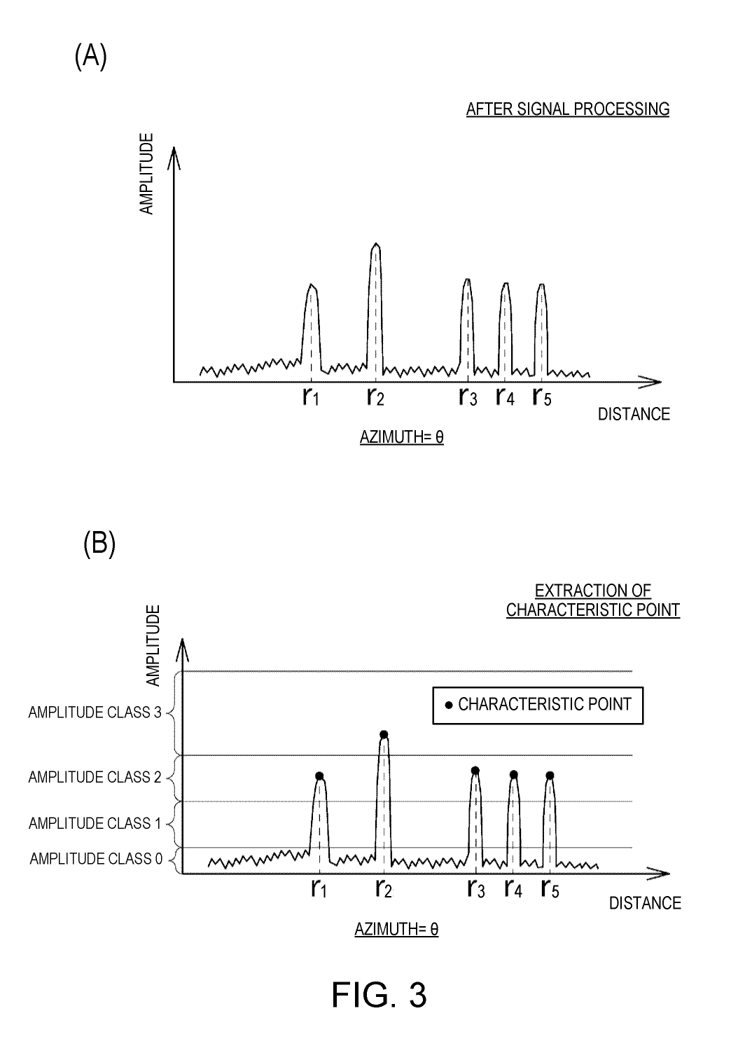

The signal processing module 14 performs processing of removing an unrequired signal, etc., on the sweep data converted into the digital signal. For example, the signal processing module 14 performs processing of removing a sea surface reflection from the sweep data, processing of removing a noise floor, processing of emphasizing the signal indicating the target object, etc. FIG. 3(A) illustrates the sweep data after such signal processing. The signal processing module 14 outputs the signal-processed sweep data to the characteristic point extracting module 15.

The characteristic point extracting module 15 extracts a characteristic point based on one or more sweep data. Specifically, there are a method of extracting the characteristic point based on a change of the amplitude over the reception signals in the distance direction from the radar antenna 11, a method of extracting the characteristic point based on a change of the amplitude over the reception signals in the azimuth direction from the radar antenna 11, a combination of these methods, etc.

First, the method of extracting the characteristic point based on the change of the amplitude over the reception signals in the distance direction is described. The change of the amplitudes can be acquired, for example, from a single sweep data as illustrated in FIGS. 2(A) and 2(B), etc.

The characteristic point extracting module 15 can extract any of various points as the characteristic point from the single sweep data. For example in this embodiment, a peak point of the change of the amplitude over the reception signals in the distance direction is the characteristic point (see FIG. 3(B)). Other than the peak point of the amplitude of the reception signal, a rising point or(and) a falling point of the amplitude may also be the characteristic point(s). Further, a median of the rising and falling points (i.e., a center position of the target object) may be the characteristic point.

The characteristic point(s) described above can be obtained by using a change amount (differential value) of the sweep data (or continuous reception signals). For example, when the change amount of the sweep data is sharply increased from zero or a value therearound, the corresponding point highly possibly indicates a rising point. Further, when the change amount of the sweep data is changed from a comparatively large value to zero or a value therearound, the corresponding point highly possibly indicates the peak point. Moreover, when the change amount of the sweep data is changed from a negative value to zero or a value therearound, the corresponding point highly possibly indicates the falling point. Furthermore, in addition to these values, the position of the peak point, etc., can be calculated more accurately by performing a calculation using a point where a second-order differential value of the sweep data is zero (inflection point). Further, the inflection point may be the characteristic point.

Further, the characteristic point extracting module 15 classifies the amplitude of the reception signal into one of four levels of amplitude classes (from class 0 to class 4) (see FIG. 3(B)). For example, the amplitude class of the target object at a distance r₁ is 2. Note that, the number of levels of amplitude classes, ranges of the amplitude corresponding to the respective amplitude classes may suitably be changed.

Further, the characteristic point extracting module 15 is configured so as not to determine a point where the amplitude is below a predetermined value (a value of which amplitude class is 0) as the characteristic point (i.e., so as not to transmit to the sensor image display device 20). Thus, a peak corresponding to a noise portion can be prevented from being extracted as the characteristic point.

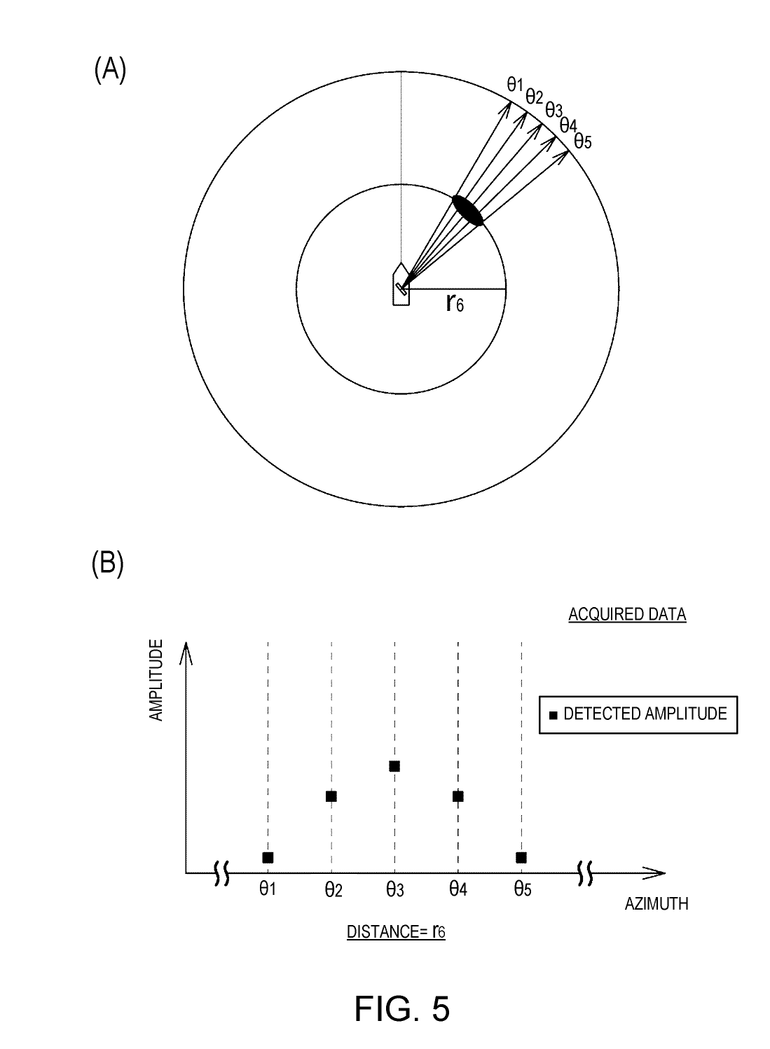

Next, a method of extracting the characteristic point based on the change of the amplitude over the reception signals in the azimuth direction is described. As illustrated in FIGS. 5(A) and 5(B), the change of the amplitude can be acquired from a plurality of sweep data. Specifically, the sensor information output device 10 extracts reception signals at a predetermined distance (r₆ in FIG. 5) from a plurality of continuous sweep data and aligns them, so as to create a chart illustrated in FIG. 5(B).

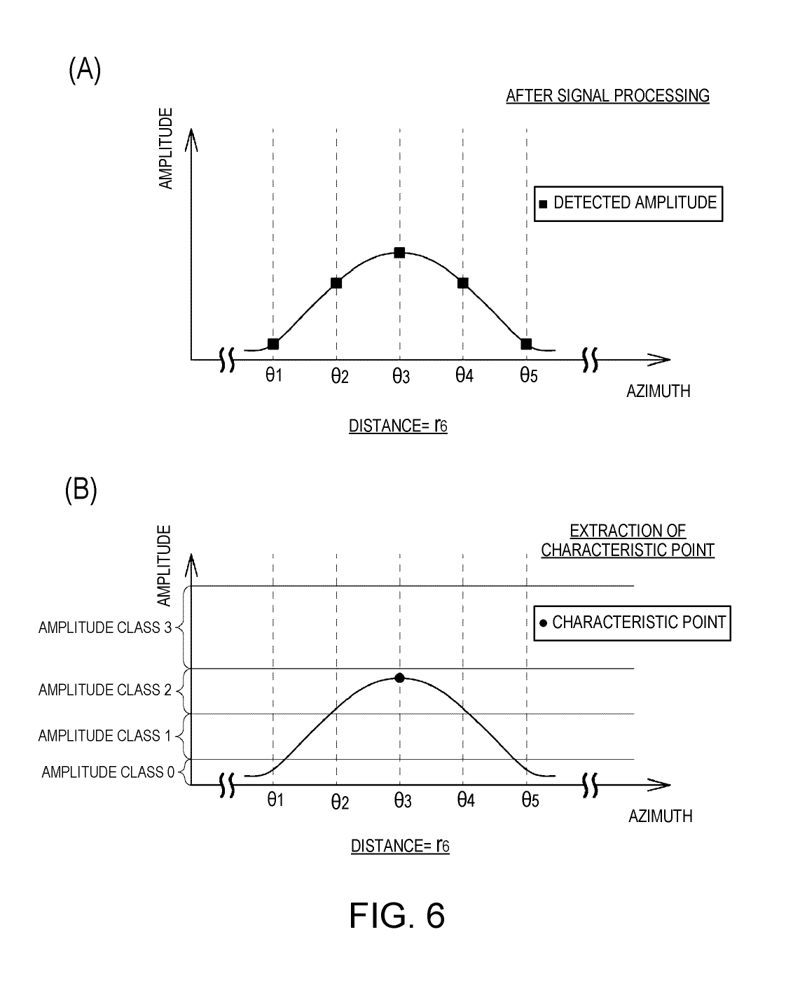

Next, the sensor information output device 10 approximates discrete data illustrated in FIG. 5(B), with a function. Thus, a chart illustrated in FIG. 6(A) is obtained. Then, the sensor information output device 10 (characteristic point extracting module 15), similar to the above description, extracts the characteristic point by performing processing of detecting the peak point, the rising point, the falling point, etc., by using, for example, a differential value of the function. In this embodiment, since the sensor information output device 10 is configured to detect the peak point, as illustrated in FIG. 6(B), the point at which the azimuth is θ₃ is extracted as the characteristic point.

Note that, in the above description, the plurality of points obtained from the plurality of sweep data are approximated with the function; however, the characteristic point may also be extracted (selected) without using the function. For example, in a case where the amplitude increases and then decreases according to the change of the azimuth, a point near the boundary between the increase and the decrease can be selected to obtain the peak point.

The supplementary information calculating module 16 calculates supplementary information of a target object corresponding to the characteristic point extracted by the characteristic point extracting module 15. In this embodiment, a speed of the target object is obtained based on a phase change of the pulse-shaped radio wave, and the obtained speed is the supplementary information of the characteristic point. Note that other information may be the supplementary information.

For example, phase information of the pulse-shaped radio wave may be the supplementary information. In this case, the speed of the target object can be obtained and used on the sensor image display device 20 side. Further, information indicating, not the speed of the target object, but only whether the target object is in move may be the supplementary information (movement information).

Furthermore, whether the sweep data indicates the target object may be determined based on a waveform, the movement information, etc., of the sweep data, so that target object determining information that is the determination result thereof becomes the supplementary information. Thus, for example, even in a case where noise, such as a sea surface reflection, is determined as the characteristic point, the noise can be prevented from being displayed as the target object on the sensor image display device 20. Note that, a configuration may be adopted, in which the characteristic point determined as other than the target object is not transmitted to the sensor image display device 20.

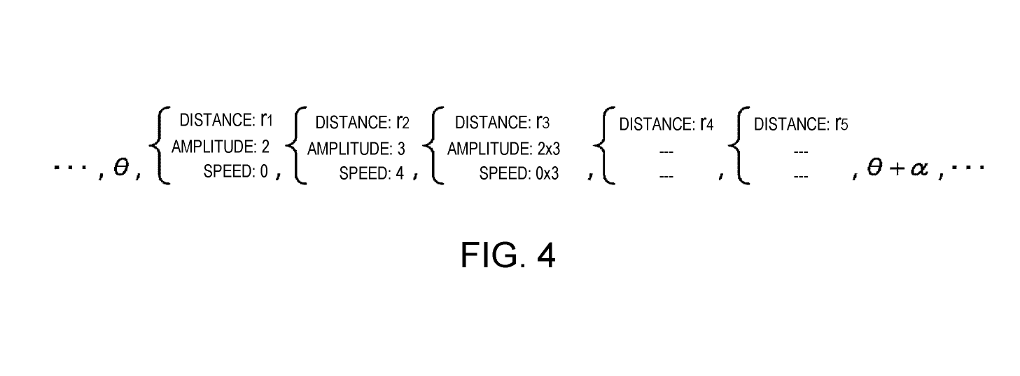

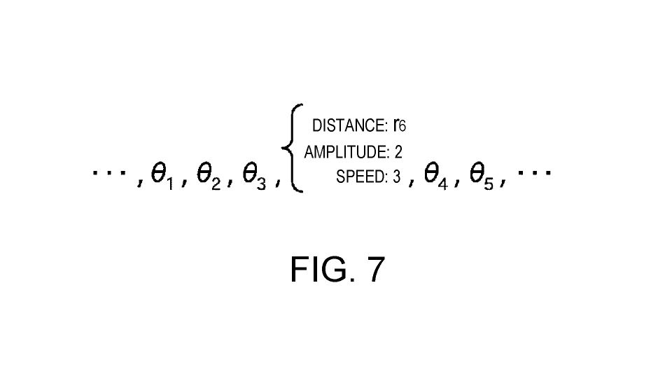

The representative data outputting module 17 outputs representative data of the reception signals to the sensor image display device 20. Hereinafter, the representative data is described with reference to FIGS. 4 and 7. FIG. 4 illustrates the representative data for outputting the characteristic points illustrated in FIG. 3(B), and FIG. 7 illustrates the representative data for outputting the characteristic point illustrated in FIG. 6(B).

As illustrated in FIGS. 4 and 7, the representative data is configured with a part indicating the azimuth (angle) of the representative data (e.g., θ and θ+α in FIG. 4, azimuth information) and a part indicating the characteristic point in the azimuth. The part indicating the characteristic point is data of the characteristic point configured with the distance from the radar antenna 11, the amplitude information (amplitude class), the supplementary information (the speed of the target object), etc.

Here, the representative data outputting module 17 transmits the representative data through run length encoding. Specifically, when adjacent characteristic points are in the same amplitude class (or indicate the same speed) as each other, the representative data outputting module 17 outputs the amplitude class and the number of the amplitude class assigned continuously. Specifically, with the representative data at a distance r₃ in FIG. 4, data indicating that the amplitude class and the speed are the same three times in a row is outputted. Thus, the transmission data amount can be reduced.

Since the representative data of FIG. 4 is configured to only output the data of the characteristic points in the sweep data, compared to the conventional configuration of outputting the data of all the points, the amount of data which is outputted from the sensor information output device 10 can significantly be reduced. Further, the sensor information output device 10 transmits, as the data of the target object, only one point that is extracted as the characteristic point within a single sweep. Therefore, the sensor information output device 10 can notify the accurate position of the target object to the sensor image display device 20.

Moreover, as illustrated in FIG. 5, the target object is detected at all the azimuths θ₁ to θ₅; however, as illustrated in FIG. 7, the sensor information output device 10 of this embodiment transmits the representative data only for θ₃ corresponding to the characteristic point. Thus, the sensor information output device 10 can notify the accurate position of the target object to the sensor image display device 20.

Furthermore, with the representative data of FIGS. 4 and 7, since the specific amplitude class of the characteristic point is displayed in a stepwise fashion as described above, the amount of the representative data can further be reduced.

The sensor information output device 10 transmits the representative data as described above. Note that, in this embodiment, the sensor information output device 10 outputs wirelessly. In general, wireless communication uses less data transfer amount per unit second(s) compared to wire communication. In this regard, since the output data amount can significantly be reduced in this embodiment compared to the conventional case, the wireless communication can be applied without any problem.

Further, in the above description, the kinds of processing of extracting the characteristic point based on the change of the amplitude over the reception signals in one of the distance and azimuth directions are described for both of the directions; however, the characteristic point can be extracted based on both of the distance and azimuth directions. For example, first in a single sweep data (reception signals continuous in the distance direction), a temporal characteristic point in the distance direction from the radar antenna 11 is extracted. Further, the same processing is performed on other sweep data obtained continuously, to extract temporal characteristic points respectively in the distance direction. Then, among the temporal characteristic points obtained from the sweep data, temporal characteristic points of which azimuths are close to each other (reception signals continuous in the azimuth direction) are compared and, for example, a temporal characteristic point at the center becomes the characteristic point. Thus, a single representative data is created for a single target object. Therefore, the position (distance and azimuth) of the target object can accurately be notified to the sensor image display device 20, as well as the output data amount can further be reduced.

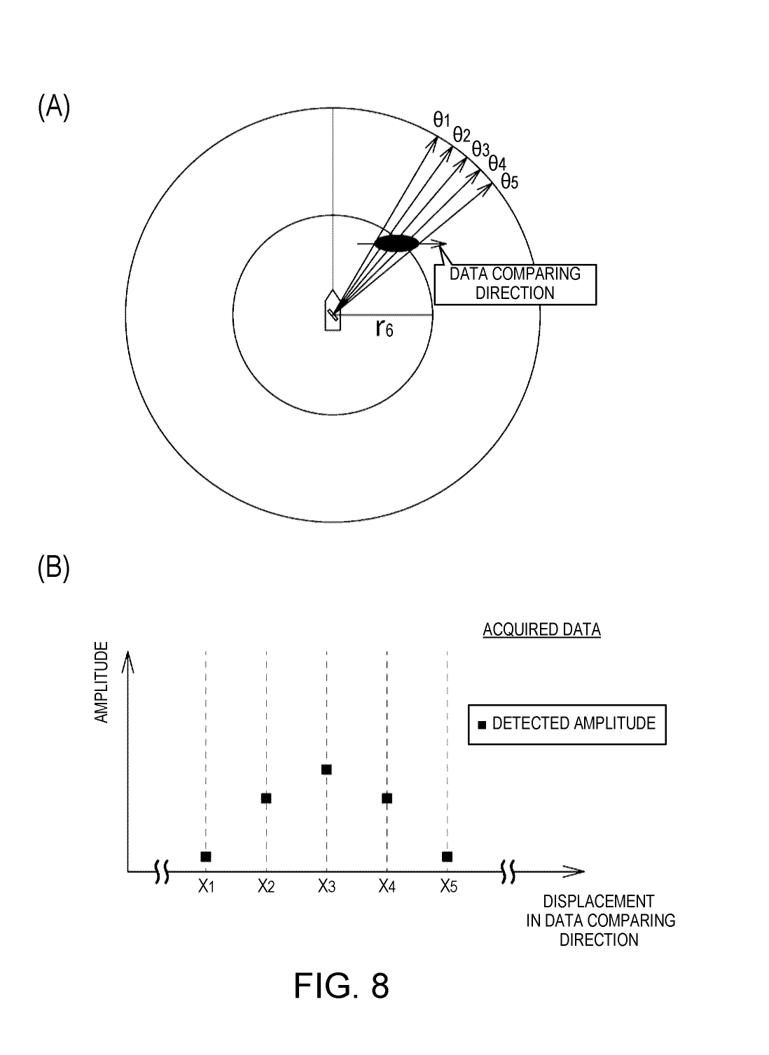

Moreover, the method of extracting the characteristic point based on both of the distance and azimuth directions is arbitrary. Other than the method described above, for example, as illustrated in FIG. 8, the amplitudes of the reception signals in a direction forming angles with both of the distance and azimuth directions (data comparing direction in FIG. 8) may be compared to select the characteristic point.

As described above, it can be said that this disclosure extracts the characteristic point based on the change of the amplitude over the reception signals in the distance direction, the azimuth direction, and directions that form an angle with the distance and azimuth directions (comprehensively referred to as the predetermined direction).

Next, the sensor image display device 20 is described. The sensor image display device 20 creates, based on the representative data received from the sensor information output device 10, a radar image (sensor image) indicating the position of the target object and displays it. As illustrated in FIG. 1, the sensor image display device 20 includes a representative data receiving module 21, an image creating module 22, and a display unit 23.

The representative data receiving module 21 receives the representative data outputted from the representative data outputting module 17. The representative data receiving module 21 outputs the representative data to the image creating module 22 upon decoding the run length encoding described above. The image creating module 22 creates the radar image indicating the target object in the vicinity based on the representative data. The display unit 23 is a display of, for example, liquid crystal or organic EL, and displays the image created by the image creating module 22.

As described above, the radar apparatus 1 creates the radar image and displays it. Note that, since the sweep data is sequentially acquired, the radar image is updated accordingly.

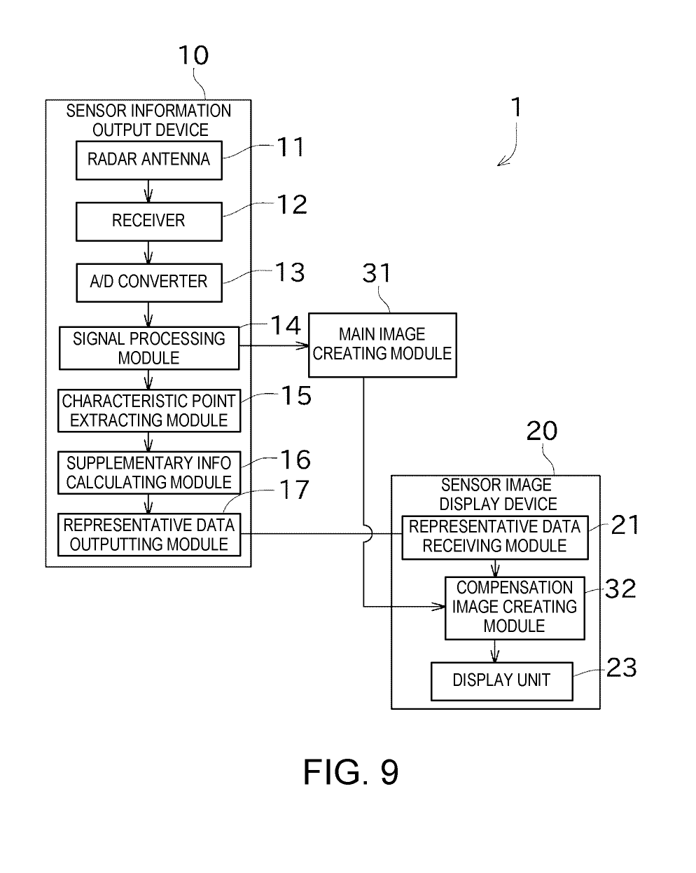

Next, a modification of the embodiment described above is described. FIG. 9 is a block diagram illustrating a configuration of the radar apparatus 1 according to the modification. Note that, in the description of the modification, the components same as/similar to those in the embodiment described above may be denoted with the same reference numerals and the description there of may be omitted.

In the embodiment described above, the radar image is created based only on the representative data. Whereas in the modification, the sensor image display device 20 creates the radar image based on both of the representative data and the sweep data.

Specifically, the radar apparatus 1 of the modification includes a main image creating module 31 and a compensation image creating module 32. The main image creating module 31 is a configuration newly added to the embodiment described above, and creates the radar image (main image) based on the sweep data. The compensation image creating module 32 performs compensation of the main image based on the representative data. For example, the compensation image creating module 32 redraws echoes in the main image by using the corresponding data of the characteristic point, so as to eliminate non-differentiatably drawn adjacent echoes or redraw the echoes when enlarged.

As described above, the sensor information output device 10 of this embodiment includes the receiver 12, the characteristic point extracting module 15, and the representative data outputting module 17. In the receiver 12, the radar antenna 11 receives the reflection waves as the reception signals, each of the reflection waves caused by the radio wave (sonic wave). The characteristic point extracting module 15 extracts the characteristic point from one or more of the reception signals. The representative data outputting module 17 outputs the representative data of the corresponding sweep data to the outside of the sensor information output device 10, the representative data corresponding to at least the distance information and the amplitude information of the characteristic point extracted by the characteristic point extracting module 15, the distance information indicating the distance from the radar antenna 11.

Thus, the output data amount can significantly be reduced. Therefore, the network traffic can be reduced. Further, since the data before the image creation is outputted instead of the data after the image creation, the image creating module 22 can draw the radar image corresponding to a resolution of the display unit 23.

Although the preferred embodiment and modification of this disclosure are described above, the above configurations may be modified as follows.

In the above description, the configuration of wirelessly outputting the representative data is adopted; however, the representative data may be outputted by wire. Also in this case, the effect that network traffic can be reduced is still exertable.

In the above description, the expression such as “the reception signals continuous in the distance direction, the azimuth direction, and the predetermined direction” is used; however, not all the reception signals in each direction need to be used, and for example, reception signals may be selected (e.g., by skipping one reception signal) to be used.

In the above description, the image adjustment, such as the adjustment in width of the peak, is performed before the coordinate conversion; however, the image adjustment may be performed after the coordinate conversion.

In the radar image, instead of the configuration of drawing the display data, the target object may be expressed with an icon, etc.

The positional arrangement of the respective components of the radar apparatus 1 is arbitrary, and it is changeable as long as the sensor information output device 10 and the sensor image display device 20 are physically separated from each other (if the signal output is required). For example, the components of one of the sensor information output device 10 and the radar antenna 11 are not necessarily disposed within the same housing as each other.

The sensor image display device 20 may not be a dedicated component configured to only display the radar image, and may be a general-purpose component also having another function. For example, it may be a display device, a PC, a smartphone, or a tablet terminal device configured to display images of a plurality of sensors.

In the above description, the example where the disclosure of the present application is applied to the radar apparatus for a ship is described; however, it may be a radar apparatus for other than a ship, for example, a radar apparatus disposed in an aircraft or a radar apparatus disposed on land and configured to detect a movable body, such as a ship.

In the above description, the example where the disclosure of the present application is applied to the radar apparatus is described; however, the present application is applicable to instruments other than the radar apparatus (e.g., a sonar or a fish finder) as long as a configuration of creating a sensor image based on a reflection wave caused by one of a radio wave and a sonic wave is adopted.

### DESCRIPTION OF REFERENCE NUMERAL(S)

1 Radar Apparatus (Detection Device)
10 Sensor Information Output Device
11 Radar Antenna (Sensor Unit)
12 Receiver
13 A/D Converter
14 Signal Processing Module
15 Characteristic Point Extracting Module
16 Supplementary Information Calculating Module
17 Representative Data Outputting Module
20 Sensor Image Display Device
21 Representative Data Receiving Module
22 Image Creating Module
23 Display Unit

1. A sensor information output device, comprising:
a receiver configured to receive reflection waves as reception signals, each of the reflection waves caused by one of a radio wave and a sonic wave transmitted from a sensor; and
a hardware processor programmed to at least:
extract a characteristic point from one or more of the reception signals; and
output representative data of the one or more of the reception signals to the outside of the sensor information output device, the representative data corresponding to at least distance information and amplitude information of the characteristic point extracted by the hardware processor, the distance information indicating a distance from the sensor.

2. The sensor information output device of claim 1, wherein the hardware processor is further programmed to extract the characteristic point based on an amplitude of the one or more of the reception signals.

3. The sensor information output device of claim 2, wherein the hardware processor is further programmed to extract the characteristic point of the one or more of the reception signals based on a change of the amplitude of the one or more of the reception signals in one of a distance direction and an azimuth direction from the sensor.

4. The sensor information output device of claim 3, wherein the hardware processor is further programmed to extract, as the characteristic point, a peak point of the change of the amplitude of the one or more of the reception signals in the one of the distance and azimuth directions from the sensor.

5. The sensor information output device of claim 3, wherein the hardware processor is further programmed to extract, as the characteristic point, an inflection point of the amplitude of the one or more of the reception signals in the one of the distance and azimuth directions from the sensor.

6. The sensor information output device of claim 3, wherein the hardware processor is further programmed to extract, as the characteristic point, a center position of a target object that is obtained based on the change of the amplitude of the one or more of the reception signals in the one of the distance and azimuth directions from the sensor.

7. The sensor information output device of claim 3, wherein the hardware processor is further programmed to extract, as the characteristic point, a point obtained based on a change amount of the amplitude of the one or more of the reception signals in the one of the distance and azimuth directions from the sensor.

8. The sensor information output device of claim 7, wherein the hardware processor is further programmed to extract, as the characteristic point, one of a rising point and a falling point of the amplitude of the one or more of the reception signals in the one of the distance and azimuth directions from the sensor.

9. The sensor information output device of claim 7, wherein the hardware processor is further programmed to extract, as the characteristic point, a point of the one or more of the reception signals at which the change amount of the amplitude in the one of the distance and azimuth directions from the sensor is above a predetermined reference amount.

10. The sensor information output device of claim 1, wherein the hardware processor is further programmed to exclude, from the output target, a point of the one or more of the reception signals at which the amplitude is below a predetermined reference amount.

11. The sensor information output device of claim 1, wherein the hardware processor is further programmed to assign the amplitude of the characteristic point into one of a plurality of amplitude classes, and outputs the assigned amplitude class as the amplitude information of the characteristic point.

12. The sensor information output device of claim 11, wherein when the hardware processor continuously assigns the amplitude of the characteristic point into the same amplitude class, the hardware processor further configured to output the amplitude class and the number of the amplitude class assigned continuously, as the amplitude information of the characteristic point.

13. The sensor information output device of claim 1, wherein the hardware processor is further configured to output phase information of the characteristic point.

14. The sensor information output device of claim 1, wherein the hardware processor is further configured to output target object determination information indicating whether the characteristic point corresponds to a target object.

15. The sensor information output device of claim 14, wherein the hardware processor is further configured to output movement information indicating whether a target object corresponding to the characteristic point is in move.

16. (canceled)

17. The sensor information output device of claim 1, wherein the hardware processor is further configured to output azimuth information of the characteristic point in addition to the distance and amplitude information of the characteristic point.

18. The sensor information output device of claim 1, wherein the hardware processor is further configured to wirelessly output the representative data.

19. The sensor information output device of claim 1, wherein the hardware processor is further configured to output, to the outside of the sensor information output device, the one or more of the reception signals before the characteristic point is extracted therefrom, in addition to the representative data.

20. A sensor image display device, comprising:
a hardware processor configured to at least:
externally receive, as representative data of one or more reception signals,
information obtained by extracting a characteristic point based on an amplitude of the one or more reception signals and including at least distance information and amplitude information of the characteristic point; and
create a sensor image indicating a target object in the vicinity, based on the representative data inputted from the hardware processor; and
a display unit configured to display the sensor image created by the hardware processor.

21. (canceled)

22. A method of outputting sensor information, comprising:
receiving reflection waves as reception signals, each of the reflection waves caused by one of a radio wave and a sonic wave transmitted from a sensor;
extracting a characteristic point from one or more of the reception signals; and
externally outputting representative data of the one or more of the reception signals, the representative data corresponding to at least distance information and amplitude information of the characteristic point extracted by the extracting the characteristic point, the distance information indicating a distance from the sensor.
